(19) United States
(12) Patent Application Publication
(10) Pub. No.: US 2026/0350557 A1
(43) Pub. Date: Nov. 5, 2026

(54) AI-Enhanced Group Formation Bot for High-Trust Community Curation

(71) Applicant: George William Bickerstaff, III, Greenwich, CT (US)

(72) Inventor: George William Bickerstaff, III, Greenwich, CT (US)

(21) Appl. No.: 19/309,971

(22) Filed: Aug. 26, 2025

(51) Int. Cl. G06Q 10/46

(52) U.S. Cl. CPC G06Q 10/46

(57) ABSTRACT

The AI-Enhanced Group Formation Bot optimizes community curation by ingesting influence metrics, applying AI-driven optimization, balancing group composition for high-trust collaboration, auditing actions for compliance, and delivering outputs via secure interfaces. It includes a metric input module for data ingestion, an AI optimization engine for group recommendation, a composition balancer for diversity and expertise, an audit logger for traceable records, and a collaboration interface for secure delivery. The method ingests metrics, optimizes groups, balances compositions, audits actions, and outputs recommendations for applications like high-trust community curation and team formation. This invention addresses inefficient group formation by enabling AI-driven, compliant, and transparent curation in digital platforms.

### CROSS-REFERENCE TO RELATED APPLICATIONS

This application claims the benefit of U.S. Provisional Patent Application No. 63/847,343, filed on Jul. 20, 2025, the entire contents of which are incorporated herein by reference.

### CPC CLASSIFICATIONS

G06Q 50/01: Organizational management; social networking
G06F 16/9535: Structured data optimization
G06N 20/00: Machine learning applications
H04L 9/32: Cryptographic mechanisms
G06Q 10/0631: Organizational planning and collaboration

### Abstract

The AI-Enhanced Group Formation Bot optimizes community curation by ingesting influence metrics, applying AI-driven optimization, balancing group composition for high-trust collaboration, auditing actions for compliance, and delivering outputs via secure interfaces. It includes a metric input module for data ingestion, an AI optimization engine for group recommendation, a composition balancer for diversity and expertise, an audit logger for traceable records, and a collaboration interface for secure delivery. The method ingests metrics, optimizes groups, balances compositions, audits actions, and outputs recommendations for applications like high-trust community curation and team formation. This invention addresses inefficient group formation by enabling AI-driven, compliant, and transparent curation in digital platforms.

### DEFINITIONS

For clarity and accurate interpretation, the following terms are defined as used in this specification (sorted alphabetically):
AI Optimization Engine: A module applying artificial intelligence algorithms, such as reinforcement learning, to recommend optimal group compositions for high-trust communities.
Audit Logger: A system component that records group formation events, outcomes, and compliance details for traceability and regulatory audits.
Collaboration Interface: An output layer providing group formation recommendations for community platforms and collaborative systems.
GDPR: General Data Protection Regulation, an EU framework governing secure processing, storage, and transfer of personal data in group formation systems.
Influence Metrics: Quantitative measures of stakeholder impact, engagement, expertise, and trust derived from diverse sources in digital platforms.

### FIELD OF THE INVENTION

This invention relates to artificial intelligence systems for optimizing group formation based on influence metrics and collaboration goals, with applications in high-trust community curation, team formation, and distributed network systems.

### BACKGROUND OF THE INVENTION

In digital platforms, the formation of effective and trusted groups is largely manual, prone to bias, and inefficient, often failing to align with community curation objectives or ensure diverse expertise. As decentralized systems grow, an AI-driven approach is needed to optimize group composition while maintaining transparency and compliance. Prior art advances machine learning for grouping and consensus but lacks high-trust community-specific, AI-enhanced group formation bots with robust auditing. The following table summarizes key prior art and their limitations, verified through patent database searches (USPTO, Google Patents, August 2025):

| Reference | Document Number | Description | Limitation | Verification |
|---|---|---|---|---|
| US20210027647A1 | US20210027647A1 | Adaptive machine | General ML-based | Verified via |
| (2021) | | learning system | recommendations; | USPTO Patent |
| | | for | lacks community | Public Search; |
| | | recommendations | curation-specific | focuses on |
| | | | group formation | adaptive ML |
| | | | | systems |
| U.S. Pat. No. | U.S. Pat. No. | On-device social | Automated | Verified via |
| 10,341,421B2 | 10,341,421B2 | grouping for | processing for | Google Patents; |
| (2019) | | automated | social grouping; | focuses on |
| | | responses | lacks influence | on-device |
| | | | optimization or | grouping, not |
| | | | high-trust group | community |
| | | | formation | curation |
| U.S. Pat. No. | U.S. Pat. No. | Establishing | Builds consensus; | Verified via |
| 10,360,191B2 | 10,360,191B2 | overlay trust | lacks AI-driven | USPTO; |
| (2019) | | consensus for | group formation | addresses |
| | | blockchain | for high-trust | blockchain |
| | | | communities | consensus |
| | | | | mechanisms |
| US20200258338A1 | US20200258338A1 | Secure consensus | Consensus systems; | Verified via |
| (2020) | | system using | lacks AI-enhanced | Google Patents; |
| | | blockchain | group formation for | focuses on |
| | | | curation | secure |
| | | | | consensus |
| | | | | protocols |
| U.S. Pat. No. | U.S. Pat. No. | Methods and | General | Verified via |
| 9,679,258B2 | 9,679,258B2 | apparatus for | reinforcement | USPTO; |
| (2017) | | reinforcement | learning; no | focuses on |
| | | learning | application to high- | reinforcement |
| | | | trust community | learning |
| | | | group formation | techniques |

These prior arts advance machine learning and consensus mechanisms but fail to provide a comprehensive system for AI-enhanced group formation with auditing and secure outputs for high-trust community curation, which this invention addresses through a structured bot with optimized processing and compliance features.

### SUMMARY OF THE INVENTION

The AI-Enhanced Group Formation Bot provides a system and method for high-trust community curation by ingesting multi-source influence metrics, applying AI-driven optimization, balancing group composition, auditing actions, and delivering secure outputs. The system includes a metric input module with aggregation and filtering, an AI optimization engine for group recommendation, a composition balancer for diversity and expertise, an audit logger for compliance and traceability, and a collaboration interface for secure delivery. The method ingests metrics, optimizes groups, balances compositions, audits actions, and outputs recommendations for community curation and team formation. Advantages include improved efficiency, diversity, GDPR compliance, transparency, and interoperability across digital platforms.

### BRIEF DESCRIPTION OF THE DRAWINGS

The drawings illustrate embodiments of the invention and are submitted as separate sheets in compliance with 37 CFR § 1.81.

FIG. 1: System Architecture Overview, depicting the overall structure and data flow of the AI-Enhanced Group Formation Bot.

FIG. 2: Optimization Pipeline, illustrating the AI-driven recommendation and scoring of groups.

FIG. 3: Composition Balancing Framework, showing the evaluation of diversity and expertise.

FIG. 4: Audit Logging Workflow, detailing the recording and storage of formation actions.

FIG. 5: Collaboration Output Processes, outlining secure delivery and integration of recommendations.

### LIST OF FIGURES WITH REFERENCE NUMBERS

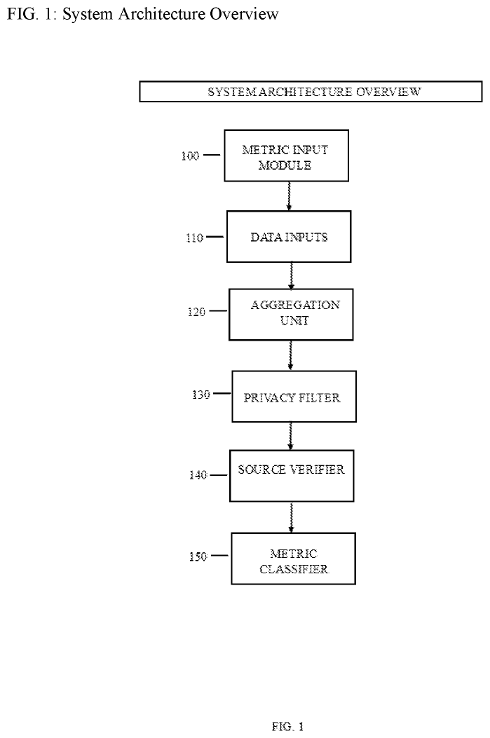

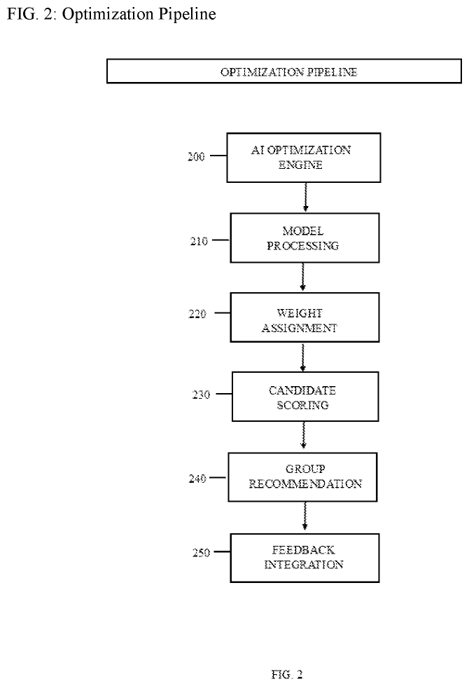

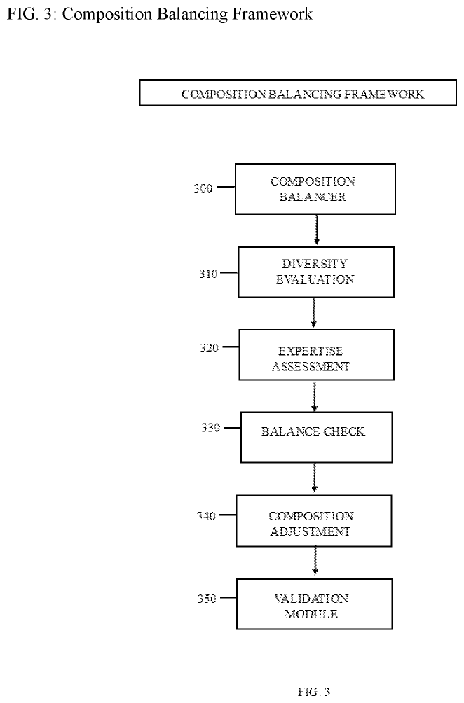

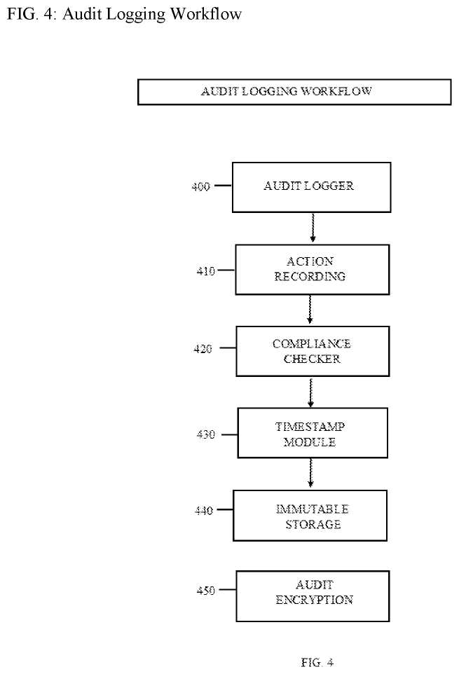

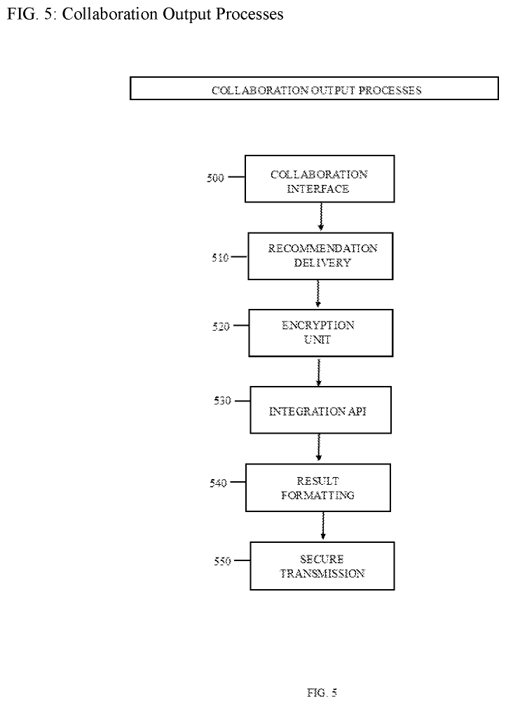

FIG. 1: System Architecture Overview
   100: Metric Input Module
   110: Data Inputs
   120: Aggregation Unit
   130: Privacy Filter
   140: Source Verifier
   150: Metric Classifier
FIG. 2: Optimization Pipeline
   200: AI Optimization Engine
   210: Model Processing
   220: Weight Assignment
   230: Candidate Scoring.
   240: Group Recommendation
   250: Feedback Integration
FIG. 3: Composition Balancing Framework
   300: Composition Balancer
   310: Diversity Evaluation
   320: Expertise Assessment
   330: Balance Check
   340: Composition Adjustment
   350: Validation Module
FIG. 4: Audit Logging Workflow
   400: Audit Logger.
   410: Action Recording
   420: Compliance Checker
   430: Timestamp Module
   440: Immutable Storage
   450: Audit Encryption
FIG. 5: Collaboration Output Processes
   500: Collaboration Interface
   510: Recommendation Delivery
   520: Encryption Unit
   530: Integration API
   540: Result Formatting
   550: Secure Transmission

### DETAILED DESCRIPTION OF THE INVENTION

This section explains how to make and use the invention, with references to the drawings. Modifications are possible within the scope, provided they do not depart from the inventive concept.

### SYSTEM OVERVIEW

As shown in FIG. 1 with reference 100, the AI-Enhanced Group Formation Bot operates in digital platforms to curate high-trust communities. It processes influence metrics from diverse sources, ensuring GDPR compliance through encryption, anonymization, and minimal data retention, supporting applications like community curation and collaborative team formation.

### Core Components

1. Metric Input Module Illustrated in FIG. 1 with reference 100, this module ingests influence metrics from platforms (reference 110). The aggregation unit (reference 120) consolidates inputs, the privacy filter (reference 130) ensures GDPR compliance via anonymization, the source verifier (reference 140) authenticates data using cryptographic signatures, and the metric classifier (reference 150) categorizes metrics for efficient processing.
2. AI Optimization Engine As shown in FIG. 2 with reference 200, this engine processes AI models (reference 210) for group formation. It assigns weights to metrics (reference 220), scores candidates (reference 230), recommends groups (reference 240), and integrates feedback (reference 250) to refine models dynamically.
3. Composition Balancer Depicted in FIG. 3 with reference 300, this balancer evaluates diversity metrics (reference 310) to ensure inclusive group composition. It assesses expertise based on credentials and influence (reference 320), performs balance checks for representation (reference 330), adjusts group composition dynamically (reference 340), and validates the final composition (reference 350) for alignment with curation goals.
4. Audit Logger Shown in FIG. 4 with reference 400, this logger records group formation actions (reference 410) for transparency. The compliance checker (reference 420) ensures adherence to regulations like GDPR, the timestamp module (reference 430) logs events chronologically, immutable storage (reference 440) uses blockchain or secure databases for tamper-proof records, and audit encryption (reference 450) protects logs while enabling authorized access.
5. Collaboration Interface As shown in FIG. 5 with reference 500, this interface delivers curation recommendations securely (reference 510). The encryption unit (reference 520) protects output data, the integration API (reference 530) supports third-party system compatibility, result formatting (reference 540) ensures outputs in formats like JSON or XML, and secure transmission (reference 550) uses cryptographic protocols for reliable delivery.

### Operational Method

The AI-Enhanced Group Formation Bot operates by:
1. Ingesting influence metrics through the input module (FIG. 1 with reference 100), aggregating via the unit (reference 120), filtering for privacy (reference 130), verifying sources (reference 140), and classifying metrics (reference 150).
2. Optimizing groups in the engine (FIG. 2 with reference 200), processing models (reference 210), assigning weights (reference 220), scoring candidates (reference 230), recommending groups (reference 240), and integrating feedback (reference 250).
3. Balancing composition in the balancer (FIG. 3 with reference 300), evaluating diversity (reference 310), assessing expertise (reference 320), checking balance (reference 330), adjusting composition (reference 340), and validating groups (reference 350).
4. Auditing actions via the logger (FIG. 4 with reference 400), recording actions (reference 410), checking compliance (reference 420), timestamping (reference 430), storing immutably (reference 440), and encrypting audits (reference 450).
5. Outputting recommendations through the interface (FIG. 5 with reference 500), delivering curation outputs (reference 510), encrypting (reference 520), integrating via API (reference 530), formatting results (reference 540), and transmitting securely (reference 550).

### Advantages

The AI-Enhanced Group Formation Bot improves curation efficiency, ensures diverse and balanced group composition, provides transparent auditing, complies with GDPR, and supports interoperability, making it ideal for high-trust community curation and team formation.

What is claimed is:

1. A computerized system for AI-enhanced group formation as shown in FIG. 1 with reference 100, comprising: one or more processors; and memory storing instructions that, when executed, cause the system to: ingest metrics via a metric input module as shown in FIG. 1 with reference 100; optimize groups using an AI optimization engine as shown in FIG. 2 with reference 200; balance compositions via a composition balancer as shown in FIG. 3 with reference 300; audit results via an audit logger as shown in FIG. 4 with reference 400; and output recommendations via a collaboration interface as shown in FIG. 5 with reference 500.

2. A computer-implemented method for AI-enhanced group formation as shown in FIG. 1 with reference 100, comprising: ingesting metrics; optimizing groups as shown in FIG. 2 with reference 200; balancing compositions as shown in FIG. 3 with reference 300; auditing results as shown in FIG. 4 with reference 400; and outputting recommendations as shown in FIG. 5 with reference 500.

3. A non-transitory computer-readable storage medium storing instructions that, when executed by a processor, cause performance of a method for AI-enhanced group formation as shown in FIG. 1 with reference 100, comprising: ingesting metrics; optimizing groups as shown in FIG. 2 with reference 200; balancing compositions as shown in FIG. 3 with reference 300; auditing results as shown in FIG. 4 with reference 400; and outputting recommendations as shown in FIG. 5 with reference 500.

4. The system of claim 1, wherein metrics include influence scores, engagement levels, and trust ratings from diverse platforms.

5. The system of claim 1, wherein optimization applies reinforcement learning and clustering as shown in FIG. 2 with reference 200.

6. The system of claim 1, wherein balancing ensures diversity and expertise as shown in FIG. 3 with reference 300.

7. The system of claim 1, wherein audits generate immutable, encrypted logs as shown in FIG. 4 with reference 450.

8. The system of claim 1, wherein outputs support community curation and collaboration applications as shown in FIG. 5 with reference 550.

9. The system of claim 1, wherein instructions adapt models dynamically based on curation needs and feedback.

10. The method of claim 2, wherein ingesting includes GDPR-compliant data handling with privacy filters as shown in FIG. 1 with reference 130.

11. The method of claim 2, wherein optimizing applies multi-objective AI models for group formation as shown in FIG. 2 with reference 240.

12. The method of claim 2, wherein balancing incorporates fairness and expertise constraints as shown in FIG. 3 with reference 340.

13. The method of claim 2, wherein auditing incorporates timestamped, immutable records as shown in FIG. 4 with reference 440.

14. The method of claim 2, wherein outputting delivers encrypted recommendations via API as shown in FIG. 5 with reference 530.
